(19) United States
(12) Patent Application Publication
(10) Pub. No.: US 2026/0134634 A1
(43) Pub. Date: May 14, 2026

(54) METHOD, APPARATUS, DEVICE AND PRODUCT FOR SPLITTING 3D MODEL

(71) Applicant: Beijing Zitiao Network Technology Co., Ltd., Beijing (CN)

(72) Inventors: Dou YIN, Beijing (CN); Weijie Xl, Beijing (CN)

(21) Appl. No.: 19/388,842

(22) Filed: Nov. 13, 2025

(30) Foreign Application Priority Data
Nov. 14, 2024 (CN) 202411630554.X

(51) Int. Cl. G06T 19/00; G06T 17/20

(52) U.S. Cl. CPC G06T 19/00; G06T 17/205; G06T 2200/24

(57) ABSTRACT

The present disclosure relates to a method, an apparatus, a device and a product for splitting a 3D model. The method comprises acquiring vertices and indexes of a mesh in a 3D model for producing a video effect, the indices being used to indicate identifiers of vertices constituting a triangular face of the 3D model. The method comprises determining whether a number of vertices satisfies a first condition. The method further comprises splitting the mesh into a plurality of sub-meshes based on the indices in response to the number satisfying the first condition, a number of vertices of each of the plurality of sub-meshes satisfying a second condition.

### CROSS-REFERENCE TO RELATED APPLICATIONS

This application claims priority to Chinese Application No. 202411630554.X, filed on November 14, 2024, the disclosure of which is incorporated herein by reference in its entirety.

### FIELD

The present disclosure relates to the field of computers, and more specifically, to a method, an apparatus, a device and a product for splitting a 3D model.

### BACKGROUND

A three-dimensional (3D) model, as a digital representation created by computer graphics technology and having 3D spatial attributes, simulates the shape, size, structure, and appearance of an object or scenario in the real world. As the core of the computer graphics technology, 3D models have undergone a rapid development——from simple geometric shapes to highly complex and realistic digital models——and have been widely used in various fields such as industrial design, architectural planning, film and television effects and game development, and have been driving the innovation and development of fields such as visual presentation and digital simulation.

Especially in the field of film and television production, the application of the 3D models has given rise to 3D effects in videos. The 3D effect of the video refers to using 3D modeling, rendering and animation technologies to introduce a 3D space effect into the content of the video, thereby creating an effect with a sense of depth, a stereoscopic effect, and realistic visual experience.

### SUMMARY

In a first aspect of embodiments of the present disclosure, there is provided a method for splitting a 3D model. The method comprises acquiring vertices and indexes of a mesh in a 3D model for producing a video effect, the indices being used to indicate identifiers of vertices constituting a triangular face of the 3D model. The method comprises determining whether a number of vertices satisfies a first condition. The method further comprises splitting the mesh into a plurality of sub-meshes based on the indices in response to the number satisfying the first condition, a number of vertices of each of the plurality of sub-meshes satisfying a second condition.

In a second aspect of embodiments of the present disclosure, there is provided a method for applying splitting of a 3D model. The method comprises, in response to detecting a user has imported the 3D model, displaying the imported 3D model on a first interface for effect production. The method further comprises determining whether a mesh of the 3D model satisfies a first condition. The method further comprises displaying a plurality of split sub-meshes on a second interface for producing the effect production in response to the mesh satisfying the first condition.

In a third aspect of embodiments of the present disclosure, there is provided an apparatus for splitting a 3D model. The apparatus comprises an acquisition module configured to acquire vertices and indices of a mesh in a 3D model for producing a video effect, the indices being used to indicate identifiers of vertices constituting a triangular face of the 3D model. The apparatus further comprises a determination module configured to determine whether a number of vertices satisfies a first condition. The apparatus further comprises a splitting module configured to split the mesh into a plurality of sub-meshes based on the indices in response to the number satisfying the first condition, a number of vertices of each of the plurality of sub-meshes satisfying a second condition.

In a fourth aspect of embodiments of the present disclosure, there is provided an apparatus for applying splitting of a 3D model. The apparatus comprises a 3D model display module configured to, in response to detecting that a user has imported the 3D model, display the imported 3D model on a first interface for effect production. The apparatus further comprises a mesh determination module configured to determine whether a mesh of the 3D model satisfies a first condition. The apparatus further comprises a mesh splitting module configured to display a plurality of split sub-meshes on a second interface for the effect production in response to the mesh satisfying the first condition.

In a fifth aspect of embodiments of the present disclosure, there is provided an electronic device. The electronic device comprises one or more processors; and a storage device for storing one or more programs which, when executed by the one or more processors, cause the one or more processors to implement a method for splitting a 3D model. The method comprises acquiring vertices and indices of a mesh in a 3D model for producing a video effect, the indices being used to indicate identifiers of vertices constituting a triangular face of the 3D model. The method comprises determining whether a number of vertices satisfies a first condition. The method further comprises splitting the mesh into a plurality of sub-meshes based on the indices in response to the number satisfying the first condition, a number of vertices of each of the plurality of sub-meshes satisfying a second condition.

In a sixth aspect of embodiments of the present disclosure, there is provided an electronic device. The electronic device comprises one or more processors; and a storage device for storing one or more programs which, when executed by the one or more processors, cause the one or more processors to implement a method for applying splitting of a 3D model. The method comprises, in response to detecting a user has imported the 3D model, displaying the imported 3D model on a first interface for effect production. The method further comprises determining whether a mesh of the 3D model satisfies a first condition. The method further comprises displaying a plurality of split sub-meshes on a second interface for the effect production in response to the mesh satisfying the first condition.

In a seventh aspect of embodiments of the present disclosure, there is provided a computer program product. The computer program product is tangibly stored on a non-transitory computer-readable medium and comprising computer-executable instructions that, when executed, cause a machine to implement a method for splitting a 3D model. The method comprises acquiring vertices and indices of a mesh in a 3D model for producing a video effect, the indices being used to indicate identifiers of vertices constituting a triangular face of the 3D model. The method comprises determining whether a number of vertices satisfies a first condition. The method further comprises splitting the mesh into a plurality of sub-meshes based on the indices in response to the number satisfying the first condition, a number of vertices of each of the plurality of sub-meshes satisfying a second condition.

In an eighth aspect of embodiments of the present disclosure, there is provided a computer program product. The computer program product is tangibly stored on a non-transitory computer-readable medium and comprising computer-executable instructions that, when executed, cause a machine to implement a method for applying splitting of a 3D model. The method comprises, in response to detecting a user has imported the 3D model, displaying the imported 3D model on a first interface for effect production. The method further comprises determining whether a mesh of the 3D model satisfies a first condition. The method further comprises displaying a plurality of split sub-meshes on a second interface for the effect production in response to the mesh satisfying the first condition.

The Summary is provided to introduce a selection of concepts in a simplified form that are further described below in the Detailed Description. This Summary is not intended to identify key features or essential features of the disclosure, nor is it intended to limit the scope of the disclosure.

### BRIEF DESCRIPTION OF THE DRAWINGS

The above and other features, advantages, and aspects of embodiments of the present disclosure will become more apparent with reference to the following detailed description when taken in conjunction with the figures. In the figures, the same or like reference numerals denote the same or like elements, wherein:

FIG. 1 illustrates a schematic diagram of an example environment in which multiple embodiments of the present disclosure may be implemented;

FIG. 2A illustrates a flow chart of a method for splitting a 3D model according to some embodiments of the present disclosure;

FIG. 2B illustrates a flow chart of a method for applying splitting of a 3D model according to some embodiments of the present disclosure;

FIG. 3 illustrates a schematic diagram of an example for splitting a mesh of a 3D model into a plurality of sub-meshes and storing the sub-meshes according to some embodiments of the present disclosure;

FIG. 4 illustrates a schematic diagram of an example flow for splitting a mesh based on a breadth-first traversal algorithm according to some embodiments of the present disclosure;

FIG. 5 illustrates a schematic diagram of an example of vertices and indices for splitting a 3D model according to some embodiments of the present disclosure;

FIG. 6A illustrates a block diagram of an apparatus for splitting a 3D model according to some embodiments of the present disclosure;

FIG. 6B illustrates a block diagram of an apparatus for applying splitting of a 3D model according to some embodiments of the present disclosure; and

FIG. 7 illustrates a block diagram of a device capable of implementing multiple embodiments of the present disclosure.

### DETAILED DESCRIPTION OF EMBODIMENTS

It may be appreciated that all user-related data involved in this solution should be obtained and used after authorization by the user. This means that, in the present technical solution, if the user’s personal information needs to be used, before such data is obtained, the user’s explicit consent and authorization are required, otherwise relevant data collection and use will not be performed. It should also be understood that in the implementation of the present technical solution, relevant laws and regulations should be strictly observed during the collection, use and storage of data, and necessary techniques and measures should be taken to ensure the safety of the user’s data and the safe use of the data.

It may be appreciated that prior to using the technical solutions disclosed in the embodiments of the present disclosure, the user should be notified of the types, scope of use, use scenario, etc. of personal information involved in the present disclosure and authorization be obtained from the user in an appropriate manner according to relevant laws and regulations.

For example, in response to reception of the user’s active request, prompt information is sent to the user to explicitly prompt the user that an operation he requests to perform needs to obtain and use his personal information. Accordingly, the user may autonomously select, according to the prompt information, whether to provide the personal information to software or hardware such as an electronic device, an application, a server or a storage medium, which executes the operations of the technical solution of the present disclosure.

As an optional but non-limiting implementation, in response to reception of the user’s active request, the prompt message may be sent to the user, for example, in the form of a pop-up in which the prompt message may be presented in a text. In addition, the pop-up may further carry a selection control for the user to select “agree” or “disagree” to provide the personal information to the electronic device.

It is to be understood that the above-described processes of notifying and obtaining the user’s authorization are merely illustrative and not be construed as limiting the implementations of the present disclosure, and that other ways of satisfying relevant laws and regulations may also be applied to the implementations of the present disclosure.

Hereinafter, embodiments of the present disclosure will be described in more detail with reference to the accompanying drawings. Although certain embodiments of the present disclosure have been illustrated in the accompanying drawings, it is to be understood that the present disclosure may be embodied in various forms and should not be construed as being limited to the embodiments set forth herein; rather, these embodiments are provided to enable the present disclosure to be understood more thoroughly and completely. It should be understood that the drawings and embodiments of the present disclosure are for illustrative purposes only and are not intended to limit the scope of the present disclosure.

In the depictions of the embodiments of the present disclosure, the term “include” and like words should be understood as being open-ended terms, i.e., meaning “include, but not limited to”. The term “based on” should be understood as “based, at least in part, on”. The term “one embodiment” or “the embodiment” should be understood as “at least one embodiment”. The terms “first”, “second” and the like may refer to different or identical objects unless expressly stated otherwise. Other explicit and implicit definitions may also be included below.

As stated above, fusing a three-dimensional spatial effects into video content can create an effect with a sense of depth, stereoscopic perception and realistic visual experience. Usually, it is challenging for ordinary effect product users to produce a 3D model. Therefore, these effect production users typically opt to further refine and create on the basis of an externally-obtained, mature 3D model to avoid the “zero-to-one” development. To enable presentation of intricate 3D modeling details, the data volume of the modeling files of these mature 3D models is often very massive. However, in the related art, when these massive modeling files are imported into software, relevant effect production platforms usually report an error because the current relevant effect production platform does not have the ability to process such massive data.

To this end, the present disclosure provides a method for splitting a 3D model with a massive amount of data, thereby enabling a user to smoothly use an effect production platform to further refine and create an effect. In embodiments of the present disclosure, a first condition for the number of vertices of a mesh of the 3D model is designed in order to ensure that the amount of data of the 3D model can be smoothly processed by the effect production platform. That is because the amount of data of the 3D model can be controlled by controlling the number of vertices of the mesh of the 3D model. The mesh of the 3D model provides the basic shape and structure of the 3D model, and the outline of the 3D model is defined by vertices, edges and triangles. Therefore, it is possible to determine whether the amount of data of the 3D model is too large by analyzing the number of vertices in its mesh ——specifically, to determine whether the number of vertices satisfies the first condition. If the first condition is satisfied, the mesh of the 3D model may be split into a plurality of sub-meshes according to indices of the mesh of the 3D model, and the number of each split meshes will satisfy a second condition. The indices here each represent an identifier indicating that the vertices of the mesh of the 3D model constitute a triangular face, thereby ensuring that the effect production platform can correctly process the relevant 3D model without causing the occurrence of an error-reporting case when the 3D model is imported.

Through this method for splitting the 3D model, a solid starting point can be set for the user to produce an effect, and meanwhile the data of sub-meshes obtained by this method for splitting the 3D model also has an effect of being compatible with a low-end hardware device, thereby improving the user’s experience in producing the effect.

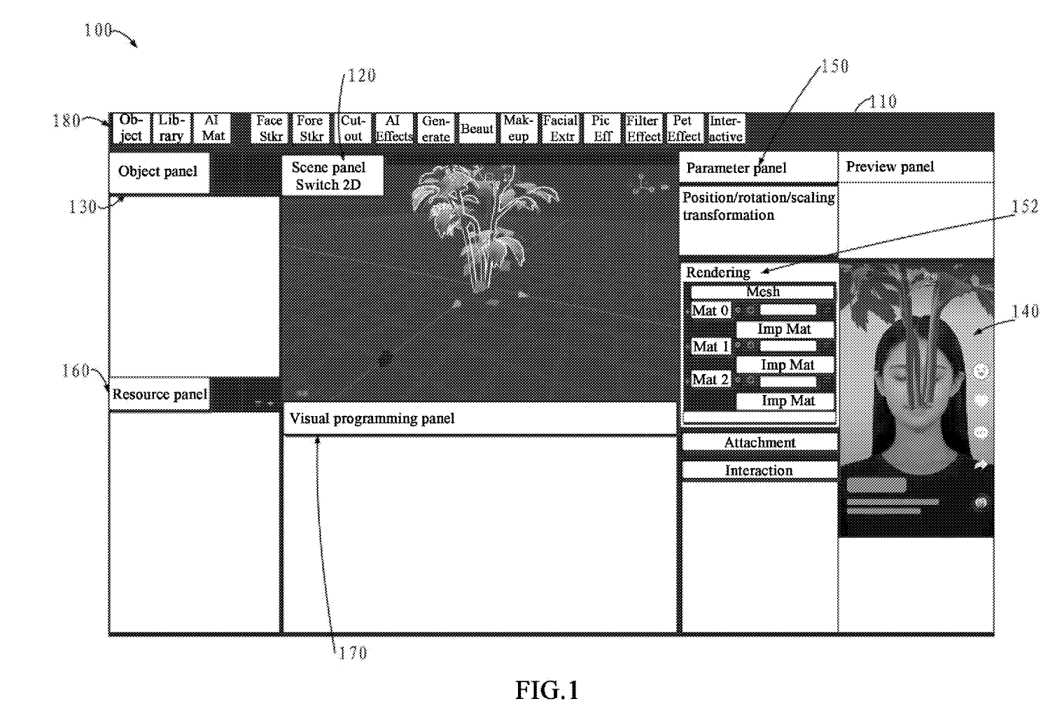

FIG. 1 illustrates a schematic diagram of an example environment 100 in which multiple embodiments of the present disclosure may be implemented. As shown in FIG. 1, a display interface 110 may be an effect production or editing page of a video effect production platform, and a user may produce an effect for a video work on the display interface 110. It should be appreciated that the display interface 110 is an effect production or editing page on a computer side, and an effect editing page similar or identical to the display interface 110 may also be displayed on other terminals (e.g., a mobile terminal), which is not limited in the present disclosure.

Referring to FIG. 1, in order to implement operations such as production, editing and preview of a video effect, there may be areas such as a scene panel 120, an object panel 130, a preview panel 140, a parameter panel 150, a resource panel 160, a visual programming panel 170, and a quick adding toolbar 180 on the display interface 110. It may be appreciated that the display positions of these functional areas may vary, for example, the positions of object panel 130 and resource panel 160 may be swapped. The division of these functional areas can help effect production users to improve the efficiency in effect production.

Referring to FIG. 1, the scene panel 120 is displayed in a middle area of the display interface 110. In some embodiments, the scene panel 120 is an area where the effect production user may make a general layout design for the entire effect. In the scene panel, the user may choose to adjust the position of an effect object in a 2D or 3D display manner.

Further referring to FIG. 1, the object panel 130 is displayed on an upper left side of the display interface 110. In some embodiments, the object panel 130 is a layer management panel which is equivalent to a “container” in which various effect objects are placed. For example, an “Add Object” control may be displayed by right-clicking on the object panel 130 area, so that effect objects such as “Facial Effects”, “2D Effects”, “3D Effects”, “AI Features”, “Interactive Features”, and “Pet Effects” may be displayed in a first-level sub-control of the “Add Object” control. A second-level sub-control which is sub-divided from the first-level sub-control may also be displayed under the first-level sub-control. For example, under the “Facial Effects” control may be displayed effect objects sub-divided from the “Facial Effects”, such as “Face-tracking Stickers”, “Makeup”, “Beautification”, “Morphing”, “Facial Feature Extraction” and “Hair Dyeing”. Through the object panel, the effect production user can easily add effect objects, and the added effect objects may then be displayed and adjusted in the scene panel 120 area.

As shown in FIG. 1, the preview panel 140 is displayed on the right side of the display interface 110. In some embodiments, the preview panel 140 can simulate a preview effect of the user’s effect in the scene. For example, the preview panel 140 may preview and display an effect of the user-produced effect displayed on a certain video platform. When the user edits the added effect objects and adjust their positions on the scene panel 120, a real-time display effect of the adjusted effect objects in the video work can be seen on the preview panel 140. There is also a camera control in the preview panel. Through the camera control, the effect production user can really see the effect of these effects when applied to on real characters.

Referring to FIG. 1, the parameter panel 150 is displayed on the left side of the preview panel 140. In some embodiments, the parameter panel 150 comprises all attributes of the effect object and components that may be added to relevant object. The parameter panel 150 needs to be used in cooperation with the object panel 130. When the parameters of the effect object need to be adjusted, the effect object may be first selected from the object panel 130 to adjust the parameters of the effect object on the parameter panel 150. On the parameter panel 150, the already-added effect object in the object panel 130 may be replaced through an “Import Material” control. At this time, the effect objects in both the scene panel 120 and preview panel 140 are also replaced synchronously.

Further referring to FIG. 1, the resource panel 160 is displayed in a left lower area of the display interface 110. In some embodiments, the resource panel 160 is an area in which all materials in the effect scene are managed in a centralized manner, the materials comprising PNG static images, PNG sequences, models, textures, etc. In the resource panel 160, operations such as freely adding and deleting may be implemented for all materials. When the user imports an effect resource through the “Import Material” control on the parameter panel 150, the imported effect resource is also synchronously displayed in the resource panel 160 area.

In FIG. 1, the user may produce some effects through the display interface 110, and may also import externally-obtained mature effects through the display interface 110, so that these mature effects may be further edited and created on the display interface 110. For example, some relatively complex 3D effects might not be particularly easy to handle for ordinary effect production users. These users may choose to import these complex 3D effects through the “Add Object” control or “Import Material” control or by dragging and dropping in the resource panel 160. In general, the 3D effects may comprise effects such as 3D model effects. The fundamental components of a 3D model comprise a mesh and a texture.

In some embodiments, after the user imports data of the 3D model, a system (e.g., an apparatus for splitting the 3D model) may first read vertex data and index data of a mesh of the imported 3D model, wherein the index represents an identifier indicating which three vertices constitute each triangle. This is because the 3D model is formed by splicing polygons, and polygons each are actually formed by splicing a plurality of triangles, that is, a surface of one 3D model is actually constituted by a plurality of triangular faces connected to each other. In the 3D space, a set of points and edges that make up these triangles is a mesh. After reading the relevant data, the system may determine whether the vertices of the mesh have satisfied a first condition which may be that the number of vertices of the mesh is greater than or equal to a certain specified number (e.g., a maximum number that can be carried by the system). It may be appreciated that the system and the effect production platform may be the same system or two separate systems.

Referring to FIG. 1, in some embodiments, if the number of these vertices does not satisfy the first condition, (i.e., if the number of these vertices satisfies a second condition), the system does not need to split the 3D model. Related data or pictures corresponding to the related data may be displayed in the object panel 130, the resource panel 160, the scene panel 120, the parameter panel 150 and the preview panel 140 of the display interface.

In some embodiments, if the number of these vertices satisfies the first condition, the system may split the mesh into a plurality of sub-meshes according to these indices of the mesh, wherein the number of split sub-meshes will satisfy the second condition, i.e., less than a specified number. In some embodiments, the data of these split sub-meshes is displayed in a mesh rendering area 152 of the parameter panel. It can be seen from the mesh rendering area 152, that the mesh of the entire 3D model is split into three sub-meshes, which are displayed in the parameter panel with item parameters Material 0, Material 1 and Material 3, respectively. This allow the user to use the data of the split sub-meshes to continue the effect production of the imported 3D model.

Through this method for splitting the 3D model, a solid starting point can be set for the user to produce an effect, and meanwhile the data of sub-meshes obtained by this method for splitting the 3D model also has an effect of being compatible with a low-end hardware device, thereby improving the user’s experience in producing the effect.

Further referring to FIG. 1, a visual programming panel 170 is displayed in a lower area of the display interface 110. In some embodiments, the visual programming panel 170 is an area for scripting a game or an interactive effect, and a node-based operation panel, and the user may use this advanced function to further process the effect. A quick operation toolbar 180 is also displayed in a left upper area of the display interface 110, is an area for quickly adding main functions, and mainly displays entries of commonly-used functions including “Add object”, “Material Library”, “AI Materials”, and “Face-tracking Stickers” etc. Through the quick operation toolbar 180, the effect production user can quickly add an effect by pressing one key.

Referring to FIG. 1, in some embodiments, after the user imports materials of the 3D model, data or pictures of the 3D model imported by the user may be displayed in the object panel 130 or the resource panel 160 or the scene panel 120 of the display interface 110. In some embodiments, after an execution apparatus for splitting the 3D model is used to read the data of the 3D model, the data including data such as the vertices of the mesh, a determination may be made as to whether the number of vertices of the mesh of the 3D model satisfies the first condition. If the 3D model satisfies the first condition, the vertices of the 3D model are split, the data of the split sub-meshes are displayed in the mesh rendering area 152 of the parameter panel, and the number of vertices of each sub-mesh of the split 3D model must satisfy the second condition. As can be seen in the mesh rendering area 152, the mesh of then entire 3D model is split into three sub-meshes, which are displayed in the parameters panel 150 as items Material 0, Material 1 and Material 3, respectively.

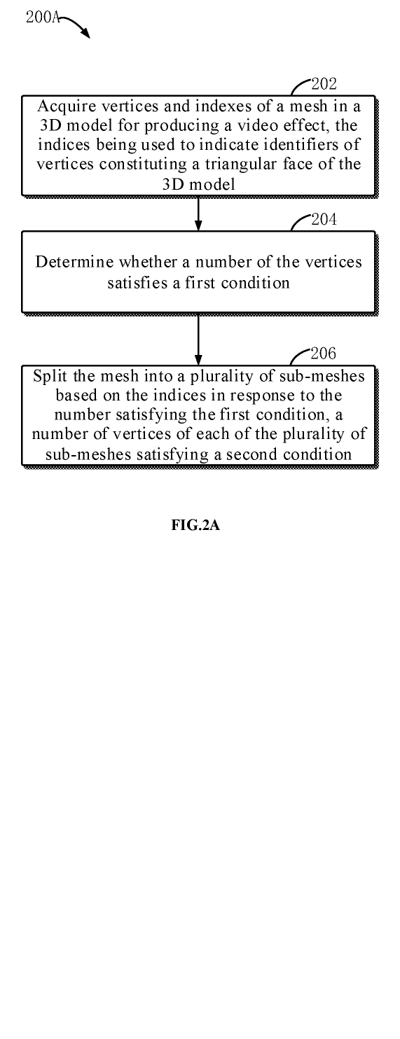

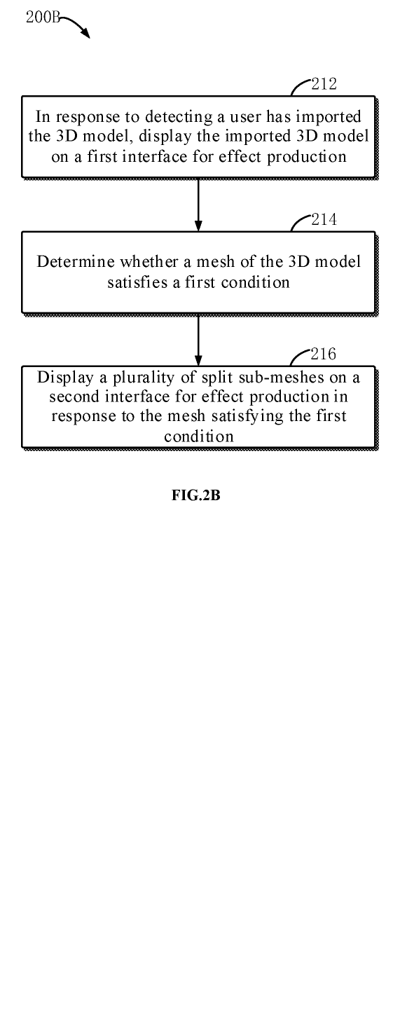

Hereinafter, a method according to an embodiment of the present disclosure will be described in detail with reference to FIG. 2A through FIG. 7. For ease of understanding, specific data mentioned in the following description is exemplary and is not intended to limit the scope of the present disclosure. It is to be understood that the embodiments described below may also include additional acts not shown and/or may omit the acts shown, and the scope of the present disclosure is not limited in this respect.

FIG. 2A illustrates a flow chart of a method 200A for splitting a 3D model according to some embodiments of the present disclosure. The method 200A may be performed by an apparatus for splitting a 3D model. The apparatus may be, for example, a stand-alone apparatus or system. The apparatus may be implemented by means of software and/or hardware. Hereunder, the method 200A will be schematically described by taking the apparatus for splitting a 3D model as an execution subject. The method 200A comprises block 202, block 204, and block 206.

As shown in FIG. 2A, at block 202, vertices and indices of a mesh in a 3D model for producing a video effect are acquired, wherein the indices each are used to indicate an identifier of vertices constituting a triangular face of the 3D model. Referring to FIG. 1, the user may produce some effects through the display interface 110, and may import externally-obtained, mature effect models through the display interface 110 to further edit and create these mature effects on the display interface 110. The user may import the 3D effect model into an effect production platform through an “Add Object” control or an “Import Material” control or by dragging and dropping in the resource panel 160. In general, the 3D effects may comprise effects such as 3D model effects. The fundamental components of the 3D model comprise a mesh and a texture. In some embodiments, after the user imports data of the 3D model, a system (e.g., an apparatus for splitting the 3D model) may first read vertex data and index data of the mesh of the imported 3D model, wherein the index represents an identifier indicating which three vertices constitute each triangle. This is because the 3D model is formed by splicing polygons, and polygons each are actually formed by splicing a plurality of triangles, that is, a surface of one 3D model is actually constituted by a plurality of triangular faces connected to each other. In the 3D space, a set of points and edges that make up these triangles is a mesh.

At block 204, a determination is made as to whether the number of vertices satisfies a first condition. In order to ensure that the amount of data of the 3D model can be smoothly processed by the effect production platform, a first condition for the number of vertices of the mesh of the 3D model is designed. That is because the amount of data of the 3D model can be controlled by controlling the number of vertices of the mesh of the 3D model. In some embodiments, after the system (e.g., an apparatus for splitting the 3D model) reads the vertex data and index data of the mesh of the imported 3D model, the system may determine whether the number of vertices of the mesh has satisfied the first condition. For example, the first condition specifies that the number of vertices must be equal to or greater than 65,535.

At block 206, the mesh is split into a plurality of sub-meshes based on the indices in response to the number satisfying the first condition, wherein the number of vertices of each of the plurality of sub-meshes satisfies a second condition. In some embodiments, if the number of these vertices satisfies the first condition, (i.e., greater than or equal to 65,535), the system may split the mesh into a plurality of sub-meshes according to these indices of the mesh, wherein the number of the sub-meshes does not exceed a number specified in the second condition, for example, the second condition specifies that the number of vertices of the split sub-meshes must be less than 65,535). In some embodiments, the data of these split sub-meshes is displayed in a mesh rendering area 152 of the parameter panel. It can be seen in the mesh rendering area 152 that the mesh of the entire 3D model is split into three sub-meshes, which are displayed in the parameter panel 150 with items material 0, material 1 and material 3, respectively, so that the user can use the data of the split sub-meshes to continue the production of the 3D effect.

The present disclosure provides a method for splitting a 3D model with a massive amount of data, thereby helping a user to smoothly use an effect production platform to further refine and create an effect. In embodiments of the present disclosure, a first condition for the number of vertices of a mesh of the 3D model is designed in order to ensure that the amount of data of the 3D model can be smoothly processed by the effect production platform. That is because the amount of data of the 3D model can be controlled by controlling the number of vertices of the mesh of the 3D model. Meanwhile, the mesh of the 3D model provides the basic shape and structure of the 3D model, and the outline of the 3D model is defined by vertices, edges and triangles. Therefore, whether the number of vertices satisfies the first condition by analyzing the vertices of the mesh of the 3D model: if the first condition is satisfied, the mesh of the 3D model may be split into a plurality of sub-meshes according to indices of the mesh of the 3D model, and the number of split meshes will satisfy a second condition. The indices here each represent an identifier of a triangular face formed by the vertices of the mesh of the 3D model, thereby ensuring that the effect production platform can correctly process the relevant 3D model without causing the occurrence of an error-reporting case when the 3D model is imported.

Through this method for splitting the 3D model, a solid starting point can be set for the user to produce an effect, and meanwhile the data of sub-meshes obtained by this method for splitting the 3D model also has an effect of being compatible with a low-end hardware device, thereby improving the user’s experience in producing the effect.

FIG. 2B illustrates a flow chart of a method 200B for applying splitting of 3D model according to some embodiments of the present disclosure. The method 200B may be performed by an apparatus for applying splitting of a 3D model. The apparatus may be, for example, a stand-alone apparatus or system. The apparatus may be implemented by means of software and/or hardware. Next, the method 200B is schematically described by taking the apparatus for splitting a 3D model as an execution subject. The method 200B comprises block 212, block 214, and block 216.

As shown in FIG. 2B, at block 212, in response to detecting the user’s import of the 3D model, the imported 3D model is displayed on a first interface for producing the effect. Referring to FIG. 1, when the user imports 3D model data through an “Add Object” control or an “Import Material” control of the quick operation toolbar 180 or by dragging and dropping in the resource panel 160, the object panel 130 or the resource panel 160 or the scene panel 120 of the display interface 110 may all display data or pictures of the 3D model imported by the user.

At block 214, a determination is made as to whether the mesh of the 3D model satisfies a first condition. In some embodiments, after an execution apparatus for applying splitting of the 3D model is used to read the data of the 3D model, the data including data such as the vertices of the mesh, a determination may be made as to whether the number of vertices of the mesh of the 3D model satisfies the first condition.

At block 216, in response to the mesh satisfying the first condition, the split sub-meshes are displayed on a second interface for producing the effect. Referring to FIG. 1, if the 3D model satisfies the first condition, the data of these split sub-meshes are displayed in the mesh rendering area 152 of the parameter panel. It can be seen in the mesh rendering area 152 that the mesh of the entire 3D model is split into three sub-meshes, which are displayed in the parameter panel 150 with items Material 0, Material 1 and Material 3, respectively.

In some embodiments, after the user imports the 3D model data into the effect production platform, it can be seen in the display interface 110 that the scene panel 120, the object panel 130, the preview panel 140, the parameter panel 150 and the resource panel 160 all display the 3D model or the data related thereto. For example, in the parameter panel 150, the user may adjust parameters for the materials of the 3D model so that changes to the 3D model corresponding to the material adjustment can be seen in the corresponding preview panel 140 or scene panel 120.

Through this method for splitting the 3D model, the data of the 3D model imported by the user can be smoothly displayed in the display interface 110, and the user can continue to produce and edit the 3D model, so that the user’s experience in producing effects is improved.

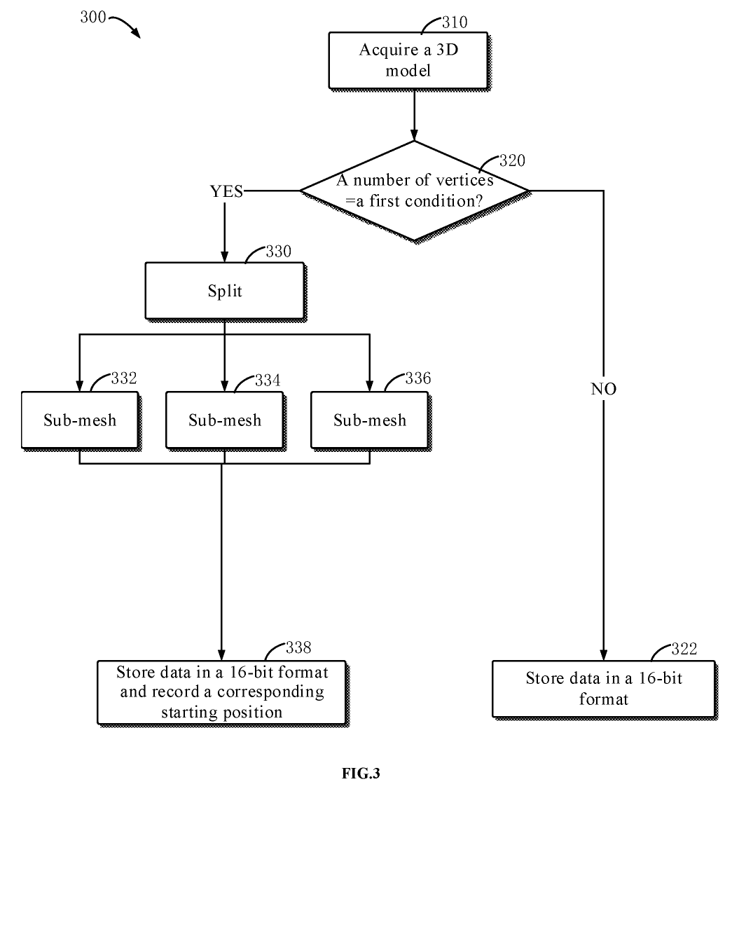

Continuing with FIG. 1, the user may import the 3D effect model into the effect production platform through the “Add Object” control or “Import Material” control or by dragging and dropping in the resource panel 160. An example of splitting the imported 3D model according to the present disclosure will be described below with reference to FIG. 3. FIG. 3 illustrates a schematic diagram of an example 300 for splitting a mesh of a 3D model into a plurality of sub-meshes and storing the sub-meshes according to some embodiments of the present disclosure. Referring to FIG. 3, at 310, a 3D model is acquired. Because the 3D model plays a crucial role in many fields such as digital content creation and video production, the 3D model is typically stored and exchanged in various formats. For example, the 3D model may be stored and exchanged in three commonly and widely-used 3D model formats: Fbx, glTF, and Obj. Fbx can maintain the integrity of information of the 3D model, such as geometry, color, texture, hierarchical relationship and animation, so it is very suitable for transmitting complex 3D scenes among multiple software. glTF, as a 3D model format optimized for Web and mobile application, stores data in a JSON format and exhibits a small volume and a fast loading speed. Obj, as a simpler 3D model format, stores data in a plain text form and is easy to read and edit. An Obj file mainly contains information such as vertices, texture coordinates and normal vectors.

Further referring to FIG. 3, in order to understand the complexity of the data of the 3D model, a determination may be made at 320 as to whether the number of vertices of the mesh of the 3D model satisfies a first condition. The 3D model is constituted by a mesh. The mesh, as a basic construction unit of the model, comprises a series of interconnected vertices, edges and faces. Therefore, the number of vertices directly reflects the complexity of the 3D model, that is, the larger the number of vertices, the more complex the shape and structure of the model, and demands for computing resources also increase correspondingly. Meanwhile, the number of vertices also affects the rendering speed and overall performance of the 3D model. In addition, considering the constraints and requirements imposed by different effect production platforms on the number of vertices of the 3D model, whether the 3D model needs to be split may be determined by determining whether the number of vertices satisfies the first condition, thereby ensuring the compatibility and stability of the 3D model on different effects production platforms.

As shown in FIG. 3, assuming that the number of vertices specified by the first condition is greater than or equal to 65K, when the number of vertices of the mesh of the 3D model satisfies the second condition ( i.e., less than 65K), the relevant data of the 3D model may be stored with a 16-bit data length or capacity directly at 322. In some embodiments, the data of the vertices of the mesh may all be stored in a first base vertex set, and connectional relationships such as indices between the vertices may be stored in a first sub-mesh set.

Referring to FIG. 3, when the number of vertices of the mesh of the 3D model is greater than 65K, the mesh of the 3D model may be split at 330 to obtain a plurality of sub-meshes, including sub-mesh 332, sub-mesh 334, and sub-mesh 336. The number of vertices of each sub-mesh is less than 65K, that is to say, the number of vertices of each sub-mesh satisfies the second condition. During the splitting of the mesh, whenever a sub-mesh has been split, the relevant data of the sub-mesh such as the connectional relationship between vertices may be stored at 338 with a 16-bit data length. In some embodiments, a starting position (i.e., a base vertex) of each sub-mesh in the original mesh vertex data needs to be accurately recorded, thereby saving the memory space and also facilitating subsequent accurate processing and presentation of the 3D model, particularly suitable for a low-end device with limited memory resources. In some embodiments, data of vertices of each sub-mesh may be stored in a second base vertex set, and the connection relationships such as indices between vertices may be stored in a second sub-mesh set.

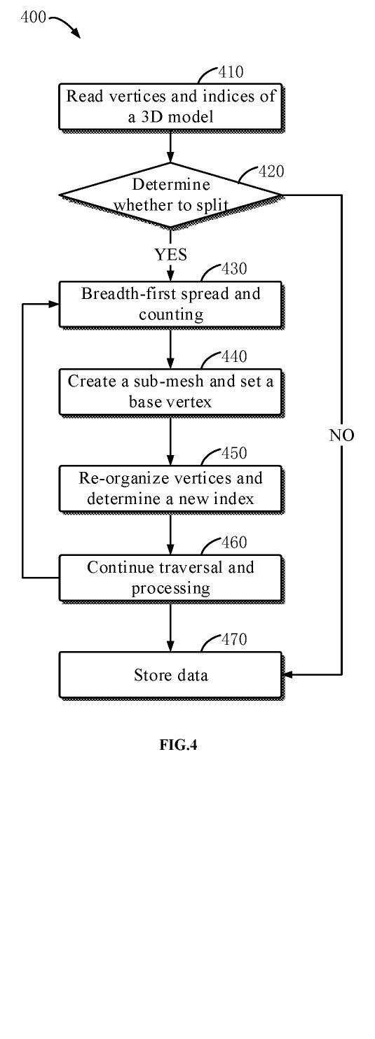

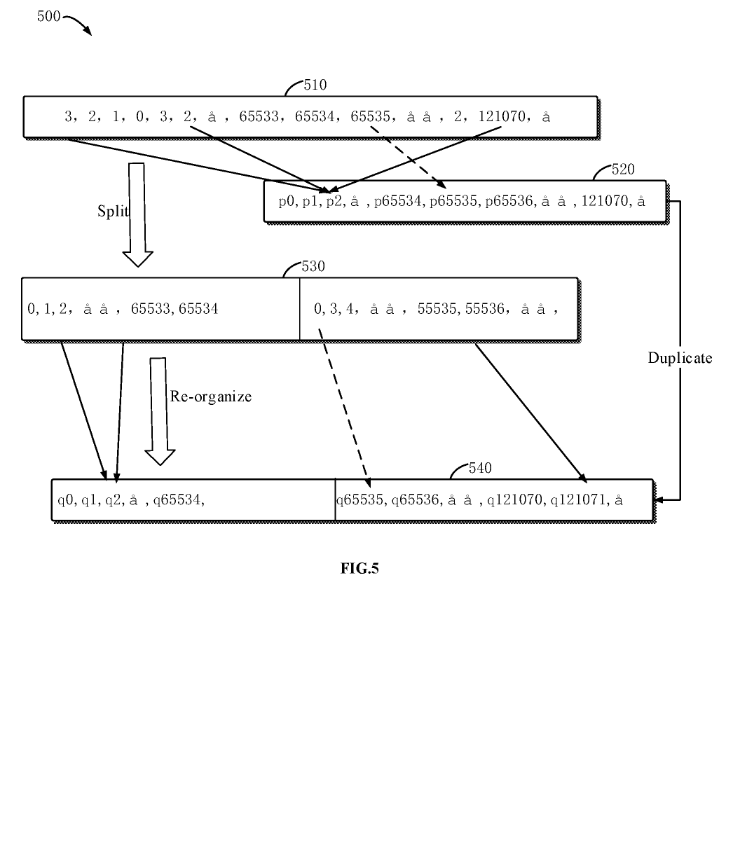

Continuing with FIG. 1, the user may import the 3D effect model into the effect production platform through the “Add Object” control or “Import Material” control or by dragging and dropping in the resource panel 160. An example of splitting the imported 3D model according to the present disclosure will be described below with reference to FIGS. 4-5. FIG. 4 illustrates a schematic diagram of an example flow 400 for splitting a mesh based on a breadth-first traversal algorithm according to some embodiments of the present disclosure. FIG. 5 illustrates a schematic diagram of an example 500 of vertices and indices for splitting a 3D model according to some embodiments of the present disclosure.

Referring to FIG. 4, when it is detected that a 3D model has been imported by a user, data of vertices and indices of the 3D model may be read at 410, wherein the indices each represent identifiers of vertices constituting a triangular face of the mesh of the 3D model. for example, index P (1, 2, 3) represents the triangular face P is constituted by connecting vertex 1, vertex 2 and vertex 3. Combing with FIG. 5, 510 in FIG. 5 displays mesh data of the 3D model. For example, “3, 2, 1 . . .” therein represents a third vertex, a second vertex and a first vertex etc. of the mesh. “p0 . . .” displayed in 520 is an identifier of an index, and represents a triangular face after vertices are connected. For example, p0 represents an identifier of a triangular face constituted by connecting vertex 3, vertex 2 and vertex1.

Further referring to FIG. 4, after the vertices and indices of the 3D model are read, a determination may be made at 420 as to whether the 3D model needs to be split, because if the amount of data of the 3D model is too large, the video effect production platform cannot load the relevant 3D model data correctly. In some embodiments, whether the 3D model is to be split and stored may be estimated by determining the number of vertices of the 3D mesh. The reason why the determination is based on the number of vertices is that the number of vertices directly reflects the complexity of the 3D model, that is, the larger the number of vertices, the more complex the shape and structure of the model, and the demands for computing resources also increase correspondingly.

As shown in FIG. 4, if a result of determination at 420 is YES, a breadth-first traversal may be performed for a vertex D of the mesh of the 3D model at 430, and counting is performed during the traversal. In some embodiments, index data T of the triangular face of the mesh of the 3D model may be searched in a breadth-first manner. The breadth-first traversal is like first searching for an area closest to a current position on a map, and then spreading outwardly gradually. In this process, a value of a counter (count) with an initial value zero may also be set to record the number of vertices that have undergone the search processing. For example, assume that the indices p0 of the three vertices of a first triangle in the original vertex data D are 0, 1, and 2, respectively (the vertex values corresponding to 510 in FIG. 5 are 3, 2, and 1). When this triangle is processed, whether the three vertices have been processed is checked. If NO, the value of the count is increased by 3 because a triangle has three vertices. At this time, the value of the counter is 3.

In some embodiments, in this process, the next triangle may continue to be processed in breadth-first order. It is assumed that the index p1 of vertices of the next triangle is 1, 3, 4 (vertex values corresponding to 510 in FIG. 5 are 2, 0, 3). At this time, it is discovered that the vertex (with a value 2) with the vertex index 1 has already been processed in the previous processing of p0, and vertices (values corresponding to 510 in FIG. 5 are 0, 3) with the vertex indices 3 and 4 are new vertices. At this time, the number of new vertices is 2, and then the value of the counter will increase by 2, and the value of the counter (count) is 5 at this time. If the number of new vertices is 1, the value of the counter will increase by 1. If there is no new vertex, the value the counter will remain unchanged.

In some embodiments, before all the traversal with respect to all indices is ended, it is necessary to continue to traverse with respect to other triangle faces in breadth-first order, and update the value of the count of the counter according to a value-adding rule of the counter every time a triangular face is processed. In some embodiments, during the traversal, it may be constantly checked whether the value of the counter (the count) is about to be greater than or equal to 65,535 as defined in the first condition.

Assuming that the search comes to the triangular face with the index p65535, it is found after calculation that the value of the counter (the count) has reached 65500, whereupon the system may create a new sub-mesh and set a base vertex at 440, because at this time the count of the counter has approached an upper limit of the number of first vertices, i.e., 65,535. In some embodiments, when a new sub-mesh object is created, the position of the new sub-mesh in the mesh of the 3D model needs to be determined. That is, the base vertex of the new sub-mesh may be set to the current value of count, i.e., 65500, which represents the position of the first vertex of this sub-mesh in the vertex data D of the mesh of the 3D model, i.e., the 65500^{th} vertex.

In some embodiments, after the base vertex of the new sub-mesh is duly set, the value of the counter may be set to zero, which may restart counting for the next round of creation of the new sub-mesh. Referring to FIGS. 5,530 shown in FIG. 5 is split by a middle vertical line as a splitting line into vertex data of two new sub-meshes.

Further referring to FIG. 4, when a new sub-mesh is created, the vertices may be rearranged and the index data updated at 450. It is assumed that in a process of continued search, a new triangular face is encountered, and all the vertices thereof are 65,502, 65,503 and 65504 respectively in the index T (the corresponding vertex values may be obtained from 510 shown in FIG. 5). It is first necessary to firstly check whether all the three vertices have appeared in a new sub-mesh with a base vertex 65,500; if the three vertices do not appear, new vertex data needs to be stored. If vertices with vertex indices of 65,502 and 65,503 once appeared in the new sub-mesh with the base vertex 65500, the data of these two vertices needn’t be stored, and only the data of the new vertex with the index 65,504 needs to be stored. Assuming that the index of the new vertex with the index 65,536 in a second new sub-mesh is 2, the indices of the vertices of the corresponding triangle in the new index data T become 0 (the corresponding index P is 65,502), 1 (the corresponding index P is 65,503),2 (the corresponding index P is 65504). In conjunction with FIGS. 5,540 shown in FIG. 5 is spit by a vertical line into indices of two re-organized sub-meshes. It may be appreciated that once a new sub-mesh is split, the base vertex of the sub-mesh needs to be recorded.

Further referring to FIG. 4, before the traversal is completed, search and process needs to be continued at 460. The above steps 430, 440, 450 are repeated to continue to search for the triangular face index data T’ until all search is completed, which can ensure that all triangular faces are properly processed and assigned to different sub-meshes. After the mesh of the 3D model is split into a plurality of sub-meshes, the sub-meshes may be stored in a corresponding storage area at 470. In some embodiments, if the result of determination at 420 is NO, the data of the 3D model may be stored directly at 470.

Through this sub-mesh splitting process, a large mesh of the 3D model can be effectively split into a plurality of small sub-meshes, to better adapt to various different hardware and software environments, and improve the efficiency and stability in processing the 3D model, thereby providing the user with a good effect production experience.

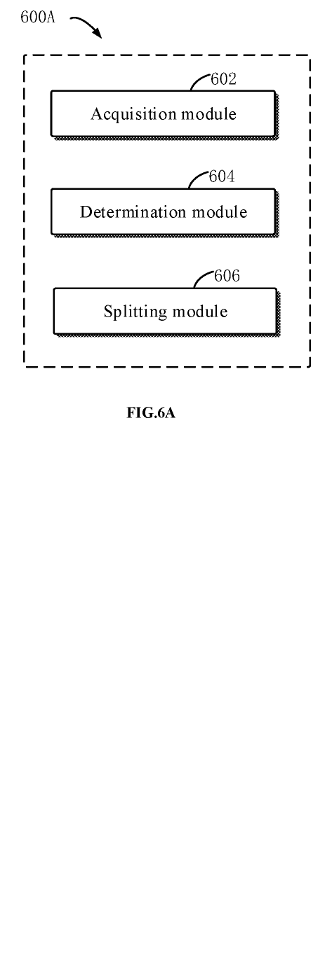

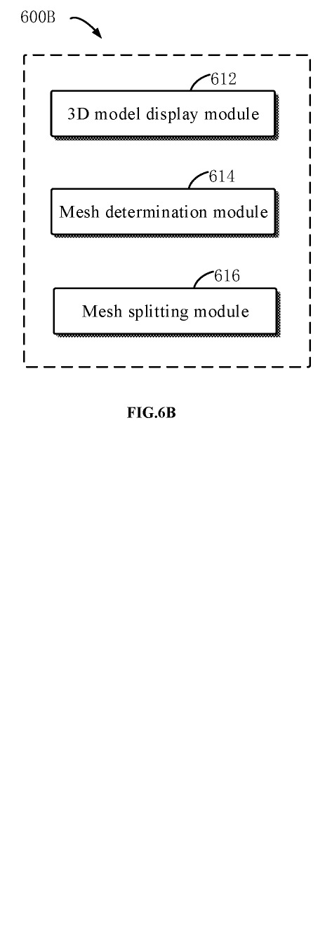

FIG. 6A illustrates a block diagram of an apparatus 600A for splitting a 3D model according to some embodiments of the present disclosure. As shown in FIG. 6A, the apparatus 600A comprises an acquisition module 602 configured to acquire vertices and indexes of a mesh in a 3D model for producing a video effect, wherein the indices are used to indicate identifiers of vertices constituting a triangular face of the 3D model. The apparatus 600A further comprises a determination module 604 configured to determine whether a number of vertices satisfies a first condition. The apparatus 600A further comprises a splitting module 606 configured to split the mesh into a plurality of sub-meshes based on the indices in response to the number satisfying the first condition, wherein a number of vertices of each of the plurality of sub-meshes satisfies a second condition.

FIG. 6B illustrates a block diagram of an apparatus 600B for applying splitting of a 3D model according to some embodiments of the present disclosure. As shown in FIG. 6B, the apparatus 600B comprises a 3D model display module 612 configured to, in response to detecting a user has imported a 3D model, display the imported 3D model on a first interface for effect production. The apparatus 600B further comprises a mesh determination module 614 configured to determine whether a mesh of the 3D model satisfies a first condition. The apparatus 600B further comprises a mesh splitting module 616 configured to display the split sub-meshes on a second interface for effect production in response to the mesh satisfying the first condition.

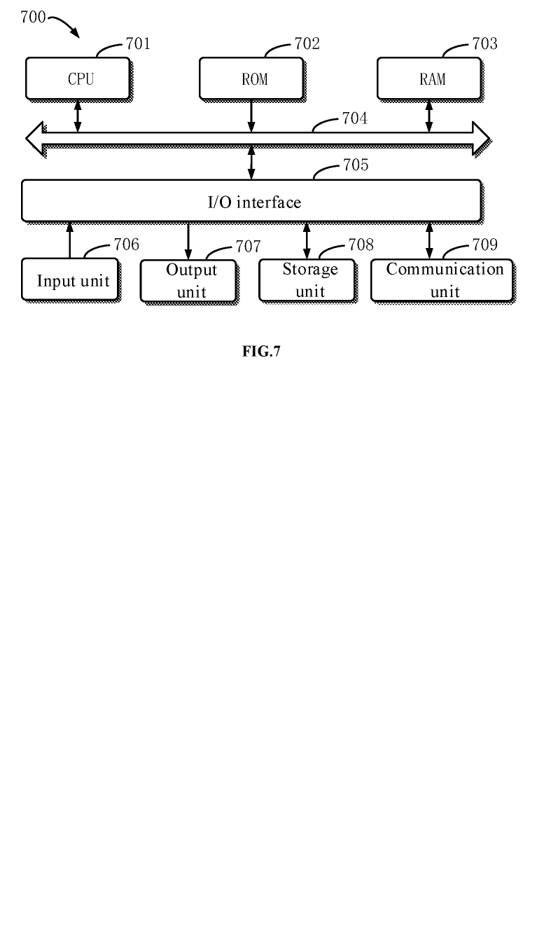

FIG. 7 illustrates a block diagram of a device 700 capable of implementing embodiments of the present disclosure. As shown in FIG. 7, the device 700 comprises a central processing unit (CPU) and/or graphics processing unit (GPU) 701 which may perform various suitable acts and processes in accordance with computer program instructions stored in a Read Only Memory (ROM) 702 or computer program instructions loaded from a storage unit 708 into a Random Access Memory (RAM) 703. In the RAM 703, various programs and data needed by the operation of the device 700 are also stored. The CPU/GPU 701, the ROM 702, and the RAM 703 are connected to one another via a bus 704. An input/output (I/O) interface 705 is also coupled to the bus 704. Although not shown in FIG. 7, the device 700 may further comprise a coprocessor.

Multiple components in the device 700 may be connected to the I/O interface 705, including: an input unit 706, for example, a keyboard, a mouse, etc.; an output unit 707 including various displays, speakers etc.; a storage unit 708 such as a magnetic disk, a DC etc.; and a communication unit 709 such as a network card, a modem, a wireless communication transceiver, etc. The communication unit 709 allows the device 700 to exchange information/data with other devices over a computer network, such as the Internet, and/or various telecommunication networks.

The methods or processes described above may be performed by CPU/GPU 701. For example, in some embodiments, the methods may be implemented as a computer software program tangibly embodied on a machine-readable medium, such as the storage unit 708. In some embodiments, part or all of the computer program may be loaded and/or installed on the device 700 via the ROM 702 and/or the communication unit 709. When the computer program is loaded into the RAM 703 and executed by the CPU/GPU 701, one or more steps or actions in the methods or processes described above may be performed.

In some embodiments, the methods and processes described above may be implemented as a computer program product. The computer program product may include a computer-readable storage medium having computer-readable program instructions embodied thereon for performing the aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language and conventional procedural programming languages. The computer readable program instructions may execute entirely on the user’s computer, partly on the user’s computer, as a stand-alone software package, partly on the user’s computer and partly on a remote computer or entirely on the remote computer or server. In the scenario involving the remote computer, the remote computer may be connected to the user’s computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to perform aspects of the present disclosure.

These computer readable program instructions may be provided to a processing unit of a general-purpose computer, a special-purpose computer, or other programmable data processing apparatus to produce a machine, such that the instructions, when executed via the processing unit of the computer or other programmable data processing apparatus, create means for implementing the functions/acts specified in one or more blocks in the flowcharts and/or block diagrams. These computer readable program instructions may also be stored in a computer readable storage medium and cause a computer, a programmable data processing apparatus, and/or other devices to function in a specific manner, such that the computer readable storage medium having instructions stored therein comprises an article of manufacture including instructions which implement aspects of the functions/acts specified in one or more blocks in the flowcharts and/or block diagrams.

The computer readable program instructions may also be loaded onto a computer, other programmable data processing apparatus, or other devices to cause a series of operational steps to be performed on the computer, other programmable apparatus or other device to produce a computer-implemented process, such that the instructions executed on the computer, other programmable apparatus, or other devices implement the functions/acts specified in one or more blocks in the flowcharts and/or block diagrams.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special-purpose hardware-based systems that perform the specified functions or acts, or implemented by combinations of special-purpose hardware and computer instructions.

The above depictions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some example implementations of the present disclosure are listed below.

Example 1. A method for splitting a 3D model, comprising:

acquiring vertices and indices of a mesh in a 3D model for producing a video effect, the indices being used to indicate identifiers of vertices constituting a triangular face of the 3D model;

determining whether a number of the vertices satisfies a first condition; and

splitting the mesh into a plurality of sub-meshes based on the indices in response to the number satisfying the first condition, a number of vertices of each of the plurality of sub-meshes satisfying a second condition.

Example 2. The method according to Example 1, wherein determining whether the number of the vertices satisfies the first condition comprises:

determining a counter for the vertices by traversing the indices, the counter being used for recording the number of vertices traversed; and

determining whether a value of the counter satisfies the first condition.

Example 3. The method according to any of Examples 1-2, wherein determining the counter for the vertices by traversing the indices comprises:

increasing the value of the counter by three in response to completion of the traversal of three vertices corresponding to each index value in the indices.

Example 4. The method according to any of Examples 1-3, the increasing the value of the counter by three in response to completion of the traversal of three vertices corresponding to each index value in the indices comprises:

determining whether all the three vertices corresponding to each index value in the indices have been traversed and recorded;

increasing the count of the counter by three in response to none of the three vertices corresponding to each index value in the indices being traversed and recorded;

increasing the value of the counter by two in response to one of the three vertices corresponding to each index value in the indices being traversed and recorded;

increasing the value of the counter by one in response to two of the three vertices corresponding to each index value in the indices being traversed and recorded; and

increasing the value of the counter by zero in response to all the three vertices corresponding to each index value in the indices being traversed and recorded.

Example 5. The method according to any of Examples 1-4, wherein splitting the mesh into the a plurality of sub-meshes based on the indices in response to the number satisfying the first condition comprises:

determining a first sub-mesh in response to the value of the counter satisfying the first condition; and

determining a first base vertex of the first sub-mesh, the first base vertex being used to record a starting position of the first sub-mesh in the vertices of the mesh; and

setting the value of the counter to zero.

Example 6. The method according to any of Examples 1-5, further comprising:

in response to creation of the first sub-mesh, determining new vertices and new indices of the mesh.

Example 7. The method according to any of Examples 1-6, further comprising:

traversing the new vertices and the new indices to determine a second sub-mesh.

Example 8. The method according to any of Examples 1-7, further comprising:

in response to a plurality of vertices in the three vertices corresponding to the new indices belonging to the first sub-mesh, referring in the second sub-mesh, to storage positions of the plurality of vertices in the first sub-mesh, and updating the new indices.

Example 9. The method according to any of Examples 1-8, further comprising:

in response to the processing of each index of the mesh in the 3D model being completed, ending the traversal of the mesh in the 3D model.

Example 10. The method according to any of Examples 1-9, further comprising:

in response to splitting the mesh in the 3D model into a plurality of sub-meshes, storing vertices of the plurality of sub-meshes in a first base vertex set, and

storing indices of the plurality of sub-meshes in a first sub-mesh set; and

in response to the number not satisfying the first condition, storing vertices of the mesh in the 3D model in a second base vertex set, and

storing the indices of the mesh in the 3D model in a second sub-mesh set.

Example 11. A method for applying splitting of a 3D model, comprising:

in response to detecting a user has imported the 3D model, displaying the imported 3D model on a first interface for producing an effect;

determining whether a mesh of the 3D model satisfies a first condition; and

displaying a plurality of split sub-meshes on a second interface for effect production in response to the mesh satisfying the first condition.

Example 12. The method according to Example 11, further comprising:

in response to an adjustment of the 3D model on a third interface for the effect production, displaying the adjusted 3D model simultaneously on a fourth interface for the effect production.

Example 13. The method according to any of Examples 11-12, further comprising:

in response to an adjustment of parameters of the 3D model on a fifth interface for the effect production, displaying the adjusted 3D model on the first interface and fourth interface simultaneously.

Example 14: An apparatus for splitting a 3D model, comprising:

an acquisition module configured to acquire vertices and indices of a mesh in a 3D model for producing a video effect, the indices being used to indicate identifiers of vertices constituting a triangular face of the 3D model;

a determination module configured to determine whether a number of the vertices satisfies a first condition; and

a splitting module configured to split the mesh into a plurality of sub-meshes based on the indices in response to the number satisfying the first condition.

Example 15. The apparatus according to Example 14, wherein the determination module comprises:

a first traversing module configure to determine a counter for the vertices by traversing the indices, the counter being used for recording the number of vertices traversed; and

a first determination module configured to determine whether a value of the counter satisfies the first condition.

Example 16. The apparatus according to any of Examples 14-15, wherein the traversing module comprises:

a first increase module configured to increase the value of the counter by three in response to completion of the traversal of three vertices corresponding to each index value in the indices.

Example 17. The apparatus according to any of Examples 14-16, wherein the first increase module comprises:

a second determination module configured to determine whether all the three vertices corresponding to the value of each index in the indices have been traversed and recorded;

a second increase module configured to increase the value of the counter by three in response to none of the three vertices corresponding to the value of each index in the indices being traversed and recorded;

a third increase module configured to increase the value of the counter by two in response to one of the three vertices corresponding to the value of each index in the indices being traversed and recorded;

a fourth increase module configured to increase the value of the counter by one in response to two of the three vertices corresponding to the value of each index in the indices being traversed and recorded; and

a first zero-setting module configured to increase the value of the counter by zero in response to all of the three vertices corresponding to the value of each index in the indices being traversed and recorded.

Example 18. The apparatus according to any of Examples 14-17, wherein the splitting module comprises:

a third determination module configured to determine a first sub-mesh in response to the value of the counter satisfying the first condition; and

a fourth determination module configured to determine a first base vertex of the first sub-mesh, the first base vertex being used to record a starting position of the first sub-mesh in the vertices of the mesh; and

a second zero-setting module configured to set the value of the counter to zero.

Example 19. The apparatus according to any of Examples 14-18, further comprising:

a further determination module configured to, in response to creation of the first sub-mesh, determining new vertices and new indices of the mesh.

Example 20. The apparatus according to any of Examples 14-19, further comprising:

a second traversing module configured to traverse the new vertices and the new indices to determine a second sub-mesh.

Example 21. The apparatus according to any of Examples 14-20, further comprising:

an updating module configured to, in response to a plurality of vertices in the three vertices corresponding to the new indices belonging to the first sub-mesh, refer in the second sub-mesh, to storage positions of the plurality of vertices in the first sub-mesh, and update the new indices.

Example 22. The apparatus according to any of Examples 14-21, further comprising:

an ending module configured to, in response to the processing of each index of the mesh in the 3D model being completed, end the traversal of the mesh in the 3D model.

Example 23. The apparatus according to any of Examples 14-22, further comprising:

a first storage module configured to, in response to splitting the mesh in the 3D model into a plurality of sub-meshes, store vertices of the plurality of sub-meshes in a first base vertex set, and

store indices of the plurality of sub-meshes in a first sub-mesh set; and

a second storage module configured to, in response to the number not satisfying the first condition, store vertices of the mesh in the 3D model in a second base vertex set, and

store the indices of the mesh in the 3D model in a second sub-mesh set.

Example 24. An apparatus for applying splitting of a 3D model, comprising:

a 3D model display module configured to, in response to detecting a user has imported the 3D model, display the imported 3D model on a first interface for effect production;

a mesh determination module configured to determine whether a mesh of the 3D model satisfies a first condition; and

a mesh splitting module configured to display a plurality of split sub-meshes on a second interface for the effect production in response to the mesh satisfying the first condition.

Example 25. The apparatus according to Example 24, further comprising:

a first display module configured to, in response to an adjustment of the 3D model on a third interface for the effect production, display the adjusted 3D model simultaneously on a fourth interface for the effect production.

Example 26. The apparatus according to any of Examples 24-25, further comprising:

a second display module configured to, in response to an adjustment of parameters of the 3D model on a fifth interface for the effect production, display the adjusted 3D model on the first interface and fourth interface simultaneously.

Example 27. An electronic device, comprising:

a processor; and

a memory coupled to the processor, the memory having instructions stored therein that, when executed by the processor, cause the electronic device to perform actions, the actions comprising:

acquiring vertices and indices of a mesh in a 3D model for producing a video effect, the indices being used to indicate identifiers of vertices constituting a triangular face of the 3D model;

determining whether a number of the vertices satisfies a first condition; and

splitting the mesh into a plurality of sub-meshes based on the indices in response to the number satisfying the first condition, a number of vertices of each of the plurality of sub-meshes satisfying a second condition.

Example 28. The electronic device according to Example 27, wherein determining whether the number of vertices satisfies the first condition comprises:

determining a counter for the vertices by traversing the indices, the counter being used for recording the number of vertices traversed; and

determining whether a value of the counter satisfies the first condition.

Example 29. The electronic device according to any of Examples 27-28, wherein determining the counter for the vertices by traversing the indices comprises:

increasing the value of the counter by three in response to completion of the traversal of three vertices corresponding to each index value in the indices.

Example 30. The electronic device according to any of Examples 27-29, the increasing the value of the counter by three in response to completion of the traversal of three vertices corresponding to each index value in the indices comprises:

determining whether all the three vertices corresponding to the value of each index in the indices have been traversed and recorded;

increasing the value of the counter by three in response to none of the three vertices corresponding to each index value in the indices being traversed and recorded;

increasing the value of the counter by two in response to one of the three vertices corresponding to each index value in the indices being traversed and recorded;

increasing the value of the counter by one in response to two of the three vertices corresponding to each index value in the indices being traversed and recorded; and

increasing the value of the counter by zero in response to all of the three vertices corresponding to each index value in the indices being traversed and recorded.

Example 31. The electronic device according to any of Examples 27-30, wherein the splitting the mesh into a plurality of sub-meshes based on the indices in response to the number satisfying the first condition comprises:

determining a first sub-mesh in response to the value of the counter satisfying the first condition; and

determining a first base vertex of the first sub-mesh, the first base vertex being used to record a starting position of the first sub-mesh in the vertices of the mesh; and

setting the value of the counter to zero.

Example 32. The electronic device according to any of Examples 27-31, further comprising:

in response to creation of the first sub-mesh, determining new vertices and new indices of the mesh.

Example 33. The electronic device according to any of Examples 27-32, further comprising:

traversing the new vertices and the new indices to determine a second sub-mesh.

Example 34. The electronic device according to any of Examples 27-33, further comprising:

in response to a plurality of vertices in the three vertices corresponding to the new indices belonging to the first sub-mesh, referring in the second sub-mesh, to storage positions of the plurality of vertices in the first sub-mesh, and updating the new indices.

Example 35. The electronic device according to any of Examples 27-34, further comprising:

in response to the processing of each index of the mesh in the 3D model being completed, ending the traversal of the mesh in the 3D model.

Example 36. The electronic device according to any of Examples 27-35, further comprising:

in response to splitting the mesh in the 3D model into a plurality of sub-meshes, storing vertices of the plurality of sub-meshes in a first base vertex set, and

storing indices of the plurality of sub-meshes in a first sub-mesh set; and

in response to the number not satisfying the first condition, storing vertices of the mesh in the 3D model in a second base vertex set, and

storing the indices of the mesh in the 3D model in a second sub-mesh set.

Example 37. An electronic device for splitting a 3D model, comprising:

in response to detecting a user has imported the 3D model, displaying the imported 3D model on a first interface for effect production;

determining whether a mesh of the 3D model satisfies a first condition; and

displaying a plurality of split sub-meshes on a second interface for the effect production in response to the mesh satisfying the first condition.

Example 38. The electronic device according to Example 37, further comprising:

in response to an adjustment of the 3D model on a third interface for producing the effect, displaying the adjusted 3D model simultaneously on a fourth interface for producing the effect.

Example 39. The electronic device according to any of Examples 37-38, further comprising:

in response to an adjustment of parameters of the 3D model on a fifth interface for producing the effect, displaying the adjusted 3D model on the first interface and fourth interface simultaneously.

Example 40. A computer-readable storage medium having stored thereon computer-executable instructions, wherein the computer-executable instructions are executed by a processor to perform the method according to any one of Examples 1 to 13.

Example 41. A computer program product tangibly stored on a computer-readable medium and comprising computer-executable instructions, the computer-executable instructions, when executed by an apparatus, cause the apparatus to perform the method according to any one of Examples 1 to 13.

Although the subject matter has been described in language specific to structural features and/or methodological actions, it should be understood that the subject matters specified in the appended claims are not limited to the specific features or actions described above. Rather, the specific features and actions described above are disclosed as example forms of implementing the claims.

I/We claim:

1. A method for splitting a 3D model, comprising:
acquiring vertices and indices of a mesh in a 3D model for producing a video effect, the indices being used to indicate identifiers of vertices constituting a triangular face of the 3D model;
determining whether a number of the vertices satisfies a first condition; and
splitting the mesh into a plurality of sub-meshes based on the indices in response to the number satisfying the first condition, a number of vertices of each of the plurality of sub-meshes satisfying a second condition.

2. The method according to claim 1, wherein determining whether the number of the vertices satisfies the first condition comprises:
determining a counter for the vertices by traversing the indices, the counter being used for recording a number of vertices traversed; and
determining whether a value of the counter satisfies the first condition.

3. The method according to claim 2, wherein determining the counter for the vertices by traversing the indices comprises:
increasing the value of the counter by three in response to completion of the traversal of three vertices corresponding to each index value in the indices.

4. The method according to claim 3, wherein the increasing the value of the counter by three in response to completion of the traversal of three vertices corresponding to each index value in the indices comprises:
determining whether all the three vertices corresponding to each index value in the indices have been traversed and recorded;
increasing the value of the counter by three in response to none of the three vertices corresponding to each index value in the indices being traversed and recorded;
increasing the value of the counter by two in response to one of the three vertices corresponding to each index value in the indices being traversed and recorded;
increasing the value of the counter by one in response to two of the three vertices corresponding to each index value in the indices being traversed and recorded; and
increasing the value of the counter by zero in response to all the three vertices corresponding to each index value in the indices being traversed and recorded.

5. The method according to claim 4, wherein splitting the mesh into the plurality of sub-meshes based on the indices in response to the number satisfying the first condition comprises:
determining a first sub-mesh in response to the value of the counter satisfying the first condition; and
determining a first base vertex of the first sub-mesh, the first base vertex being used to record a starting position of the first sub-mesh in the vertices of the mesh; and
setting the value of the counter to zero.

6. The method according to claim 5, further comprising:
in response to creation of the first sub-mesh, determining new vertices and new indices of the mesh.

7. The method according to claim 6, further comprising:
traversing the new vertices and the new indices to determine a second sub-mesh.

8. The method according to claim 7, further comprising:
in response to a plurality of vertices in the three vertices corresponding to the new indices belonging to the first sub-mesh, referring, in the second sub-mesh, to storage positions of the plurality of vertices in the first sub-mesh, and updating the new indices.

9. The method according to claim 2, further comprising:
in response to the processing of each index of the mesh in the 3D model being completed, ending the traversal of the mesh in the 3D model.

10. The method according to claim 1, further comprising:
in response to splitting the mesh in the 3D model into a plurality of sub-meshes, storing vertices of the plurality of sub-meshes in a first base vertex set, and
storing indices of the plurality of sub-meshes in a first sub-mesh set; and
in response to the number not satisfying the first condition, storing vertices of the mesh in the 3D model in a second base vertex set, and
storing the indices of the mesh in the 3D model in a second sub-mesh set.

11. A method for applying splitting of a 3D model, comprising:
in response to detecting a user has imported the 3D model, displaying the imported 3D model on a first interface for effect production;
determining whether a mesh of the 3D model satisfies a first condition; and
displaying a plurality of split sub-meshes on a second interface for the effect production in response to the mesh satisfying the first condition.

12. The method according to claim 11, further comprising:
in response to an adjustment of the 3D model on a third interface for the effect production, displaying the adjusted 3D model simultaneously on a fourth interface for the effect production.

13. The method according to claim 12, further comprising:
in response to an adjustment of parameters of the 3D model on a fifth interface for the effect production, displaying the adjusted 3D model on the first interface and the fourth interface simultaneously.

14. An electronic device, comprising:
a memory and a processor;
wherein the memory is configured to store one or more computer instructions which, when executed by the processor, cause the processor to:
acquire vertices and indices of a mesh in a 3D model for producing a video effect, the indices being used to indicate identifiers of vertices constituting a triangular face of the 3D model;
determine whether a number of the vertices satisfies a first condition; and
split the mesh into a plurality of sub-meshes based on the indices in response to the number satisfying the first condition, a number of vertices of each of the plurality of sub-meshes satisfying a second condition.

15. The device according to claim 14, wherein the instructions causing the processor to determine whether the number of the vertices satisfies the first condition comprise instructions causing the processor to:
determine a counter for the vertices by traversing the indices, the counter being used for recording a number of vertices traversed; and
determine whether a value of the counter satisfies the first condition.

16. The device according to claim 15, wherein the instructions causing the processor to determine the counter for the vertices by traversing the indices comprise instructions causing the processor to:
increase the value of the counter by three in response to completion of the traversal of three vertices corresponding to each index value in the indices.

17. The device according to claim 16, wherein the instructions causing the processor to increase the value of the counter by three in response to completion of the traversal of three vertices corresponding to each index value in the indices comprise instructions causing the processor to:
determine whether all the three vertices corresponding to each index value in the indices have been traversed and recorded;
increase the value of the counter by three in response to none of the three vertices corresponding to each index value in the indices being traversed and recorded;
increase the value of the counter by two in response to one of the three vertices corresponding to each index value in the indices being traversed and recorded;
increase the value of the counter by one in response to two of the three vertices corresponding to each index value in the indices being traversed and recorded; and
increase the value of the counter by zero in response to all the three vertices corresponding to each index value in the indices being traversed and recorded.

18. The device according to claim 17, wherein the instructions causing the processor to split the mesh into the plurality of sub-meshes based on the indices in response to the number satisfying the first condition comprise instructions causing the processor to:
determine a first sub-mesh in response to the value of the counter satisfying the first condition; and
determine a first base vertex of the first sub-mesh, the first base vertex being used to record a starting position of the first sub-mesh in the vertices of the mesh; and
set the value of the counter to zero.

19. The device according to claim 18, further comprising instructions causing the processor to:
in response to creation of the first sub-mesh, determine new vertices and new indices of the mesh.

20. The device according to claim 18, further comprising instructions causing the processor to:
traverse the new vertices and the new indices to determine a second sub-mesh.
